(19) United States
(12) Patent Application Publication
(10) Pub. No.: US 2026/0278597 A1
(43) Pub. Date: Sep. 17, 2026

(54) SYSTEM AND A METHOD FOR PROVIDING CONSENSUS TO A TRANSACTION RECORD IN A DISTRIBUTED LEDGER AND A PAYMENT SYSTEM

(71) Applicant: Logistics and Supply Chain MultiTech R&D Centre Limited, Pok Fu Lam (HK)

(72) Inventors: Tsz Ho Pun, Pok Fu Lam (HK); Yi Jun He, Pok Fu Lam (HK); Chun Fai Chan, Pok Fu Lam (HK); Chung Dak Shum, Pok Fu Lam (HK)

(21) Appl. No.: 19/079,660

(22) Filed: Mar. 14, 2025

(51) Int. Cl. G06Q 20/38; G06Q 20/40; H04L 9/08; H04L 9/32

(52) U.S. Cl. CPC G06Q 20/3829; G06Q 20/3825; G06Q 20/401; H04L 9/0825; H04L 9/3247

(57) ABSTRACT

A system and a method for providing consensus to a transaction record in a distributed ledger and a payment system. The system includes a processor operating in a trusted execution environment (TEE) arranged to generate a plurality of digital signature in the TEE using a private key of a respective one of a plurality of replica, wherein the private keys are stored in the TEE; wherein the plurality of replicas includes a leader being elected from the plurality of replicas associated with the transaction record in the distributed ledger; and wherein the plurality of digital signature is included in a commit message provided by the leader to a client in a reply, and the commit message further includes a log entry requested by the client.

### FIELD OF THE INVENTION

The present invention relates to a system and a method for providing consensus to a transaction record in a distributed ledger and a payment system, and particularly, although not exclusively, to a system and a method facilitating assisted and reliable agreement in distributed ledger.

### BACKGROUND OF THE INVENTION

The concept of Central Bank Digital Currency (CBDC) has become a hot research topic among central banks worldwide. Often, the focus is on wholesale CBDC, which aims to enhance the efficiency of cross-border settlements. This interest in CBDCs is driven by the potential to streamline financial transactions and improve the overall financial infrastructure.

In the context of Hong Kong, the Hong Kong Monetary Authority (HKMA) has been exploring the digitalization of the Hong Kong Dollar through a retail or general-purpose CBDC (rCBDC), known as e-HKD. A whitepaper published by HKMA in October 2021 outlines the vision and framework for e-HKD. The proposed model for retail CBDC involves a two-tier distribution system. The wholesale interbank system includes central banks, commercial banks, and payment service providers, while the retail system involves banks and the general public.

Distributed Ledger Technology (DLT) is identified as essential for the implementation of rCBDC in the HKMA whitepaper. The DLT-based wholesale interbank system ensures secure and efficient transactions among financial institutions. Additionally, validators in the retail system can operate collectively in a DLT manner, enhancing the security and reliability of the system. However, the whitepaper also highlights performance concerns, particularly the trade-offs between performance and security. The challenge lies in balancing high performance with security, as high performance may lead to insecurity, while low performance may ensure security but at the cost of efficiency.

### SUMMARY OF THE INVENTION

An objective of the invention is to provide a consensus system that achieves high performance while being able to resist Byzantine faults, making it suitable for a transaction processing system. If all replicas are permissioned, consistent ordering of transactions across replicas may be important. This balance between performance and security may be vital for the successful implementation of electronic currencies and other similar digital currency initiatives.

In accordance with a first aspect of the present invention, there is provided a system for providing consensus to a transaction record in a distributed ledger, comprising a processor operating in a trusted execution environment (TEE) arranged to generate a plurality of digital signature in the TEE using a private key of a respective one of a plurality of replica, wherein the private keys are stored in the TEE; wherein the plurality of replicas includes a leader being elected from the plurality of replicas associated with the transaction record in the distributed ledger; and wherein the plurality of digital signature is included in a commit message provided by the leader to a client in a reply, and the commit message further includes a log entry requested by the client.

In accordance with the first aspect, the distributed ledger is implemented by a blockchain network comprising the plurality of replicas.

In accordance with the first aspect, the plurality of digital signature in the commit message is in form of an aggregated signature.

In accordance with the first aspect, the aggregated signature is a threshold signature having a threshold (n, t) denoting at least t out of n replicas agree on the log entry in a voting process.

In accordance with the first aspect, the aggregated signature is verified in the TEE using a single public key.

In accordance with the first aspect, the transaction record is an arbitrary record corresponding to the log entry committed by the replicas, such as an operation of minting, burning, transferring, locking or unlocking fund in a payment system.

In accordance with a second aspect of the present invention, there is provided a method of providing consensus to a transaction record in a distributed ledger, comprising the steps of:
electing a leader from a plurality of replicas associated with the transaction record in the distributed ledger; and replying, by the leader, a commit message to a client, wherein the commit message includes a log entry requested by the client and a plurality of digital signatures of the plurality of replicas; wherein the each of the plurality of digital signatures is generated using a private key of the respective one of the plurality of replicas; and wherein the private keys are stored in a trusted execution environment (TEE) and the generation of the plurality of digital signatures is executed in the TEE.

In accordance with the second aspect, the distributed ledger is implemented by a blockchain network comprising the plurality of replicas.

In accordance with the second aspect, the plurality of digital signature in the commit message is in form of an aggregated signature.

In accordance with the second aspect, the aggregated signature is a threshold signature having a threshold (n, t) denoting at least t out of n replicas agree on the log entry in a voting process.

In accordance with the second aspect, the aggregated signature is verified in the TEE using a single public key.

In accordance with the second aspect, the transaction record is an arbitrary record corresponding to the log entry committed by the replicas, such as an operation of minting, burning, transferring, locking or unlocking fund in a payment system.

In accordance with a third aspect of the present invention, there is provided a payment system comprising: a distributed ledger arranged to record a transaction record upon receiving a log entry requested by a client, wherein the distributed ledger is implemented with a plurality of replicas; a consensus module arranged to provide consensus to the transaction record in the distributed ledger; wherein the consensus module includes a processor operating in a trusted execution environment (TEE) arranged to generate a plurality of digital signature in the TEE using a private key of a respective one of a plurality of replica, wherein the private keys are stored in the TEE; wherein the plurality of replicas includes a leader being elected from the plurality of replicas associated with the transaction record in the distributed ledger; and wherein the plurality of digital signature is included in a commit message provided by the leader to the client in a reply, and the commit message further includes the log entry requested by the client.

In accordance with the third aspect, the distributed ledger is implemented by a blockchain network comprising the plurality of replicas.

In accordance with the third aspect, the plurality of digital signature in the commit message is in form of an aggregated signature.

In accordance with the third aspect, the aggregated signature is a threshold signature having a threshold (n, t) denoting at least t out of n replicas agree on the log entry in a voting process.

In accordance with the third aspect, the aggregated signature is verified in the TEE using a single public key.

In accordance with the third aspect, the transaction record is associated with an operation of minting, burning, transferring, locking or unlocking fund.

In accordance with the third aspect, the client includes an electronic terminal operated by a central bank, a financial institution, a payment service provider or a user of financial services.

In accordance with the third aspect, a response time between receiving the log entry and providing the commit message is less than or equal to 5 seconds.

### BRIEF DESCRIPTION OF THE DRAWINGS

Embodiments of the present invention will be described with reference to the accompanying drawings:

FIG. 1 is an illustration of a computer system for being implemented as system for providing consensus to a transaction record in a distributed ledger in accordance with an embodiment of the present invention.

FIG. 2 is a flow diagram illustrating a method of providing consensus to a transaction record in a distributed ledger in accordance with an embodiment of the present invention.

FIG. 3A is a chart showing a benchmarking result comparing average response time against number of nodes based on Raft, MinBFT and the method in accordance with an embodiment of the present invention.

FIG. 3B is a chart showing a benchmarking result comparing average response time against number of nodes based on Raft, MinBFT and the method in accordance with an embodiment of the present invention.

FIG. 4A is a screenshot of performance matrices of the blockchain running Raft consensus.

FIG. 4B is a screenshot of performance matrices of the system performing consensus process in accordance with an embodiment of the present invention.

FIG. 4C is a plot showing a comparison of results in FIGS. 4A and 4B.

FIG. 5 is a block diagram showing a performance testing setup for evaluating a system in accordance with an embodiment of the present invention.

FIG. 6 is an illustration showing an HTML report generated by Hyperledger Caliper after each benchmarking experiment.

FIG. 7 is chart showing a throughput performance achieved by the system of FIG. 5.

FIG. 8 is chart showing a response time performance achieved by the system of FIG. 5.

FIG. 9 is an illustration showing an example two-tier distribution model for retail CBDC extracted from the whitepaper published by HKMA.

FIG. 10 is an illustration showing example transaction facilitated by a payment system in accordance with an embodiment of the present invention.

FIG. 11 is a screenshot showing user interfaces of a software platform operating a mint fund and a burn fund operation.

FIG. 12 is a screenshot showing user interfaces of a software platform operating a transfer fund and a lock fund operation.

FIG. 13 is a screenshot showing user interfaces of a software platform operating a transaction review and a balance review operation.

### DETAILED DESCRIPTION OF ILLUSTRATIVE EMBODIMENTS

The terminology used herein is for the purpose of describing particular embodiments only and is not intended to be limiting to the invention. As used herein, the term “and/or” includes any and all combinations of one or more of the associated listed items. As used herein, the singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

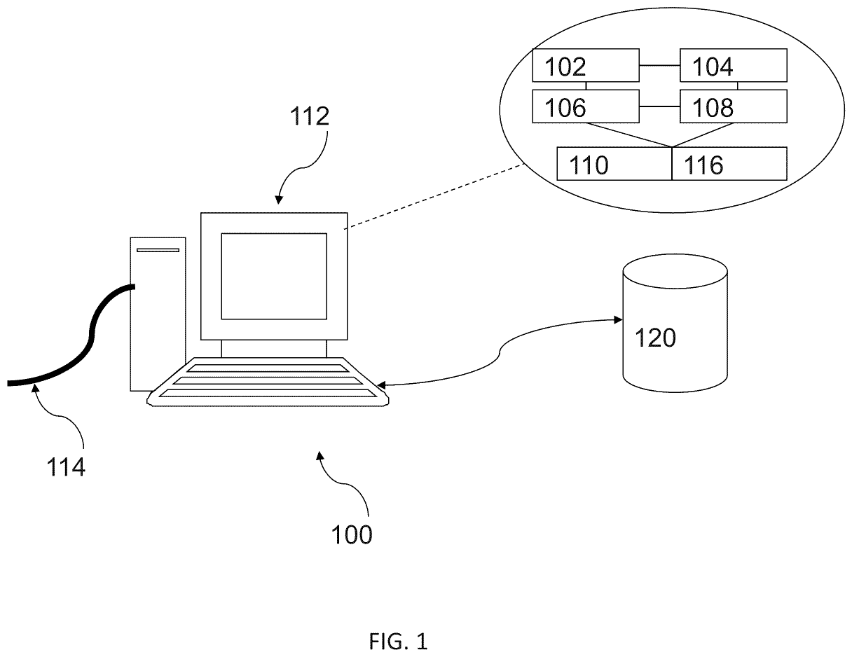

With reference to FIG. 1, there is shown an embodiment of a system for providing consensus to a transaction record in a distributed ledger, comprising: a processor operating in a trusted execution environment (TEE) arranged to generate a plurality of digital signature in the TEE using a private key of a respective one of a plurality of replica, wherein the private keys are stored in the TEE; wherein the plurality of replicas includes a leader being elected from the plurality of replicas associated with the transaction record in the distributed ledger; and wherein the plurality of digital signature is included in a commit message provided by the leader to a client in a reply, and the commit message further includes a log entry requested by the client.

In this embodiment, the processor may be a crypto processor capable of signing or verifying data information in electronic form, by using cryptographic keys or encryption keys provided by “owners” of the key. For example, it may be necessary for a payment system to process a transaction which leads to a generation of a new entry of record that should be recorded in a digital ledger, the transaction, or the new log entry associated with the transaction is preferably signed and/or verified before the transaction is logged, especially when the request of log is provided by a system or terminal which is different from the system implementing the ledger.

Without wishing to be bound by theory, the term “Trusted Execution Environment” (TEE) may refer to a secure area within a processing system or a server. It may ensure that sensitive data is stored, processed, and protected in an isolated and secure environment, thus may provide a higher level of security by protecting code and data from unauthorized access or tampering, even if the main operating system is compromised.

Advantageously, TEE may be employed to enhance the security and efficiency of the consensus process. For example, in blockchain and IoT applications, TEEs can ensure that the data and operations involved in reaching consensus are trustworthy and tamper-proof.

Preferably, the TEE may be implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

As shown in FIG. 1 there is a shown a schematic diagram of a computer system or computer server 100 which is arranged to be implemented as an example embodiment of the present invention. In this embodiment the system comprises a server 100 which includes suitable components necessary to receive, store and execute appropriate computer instructions. The components may include a processing unit 102, including Central Processing United (CPUs), Math Co-Processing Unit (Math Processor), for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114.

The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link. The server 100 may include storage devices such as a disk drive 108 which may encompass solid state drives, hard disk drives, optical drives, magnetic tape drives or remote or cloud-based storage devices. The server 100 may use a single disk drive or multiple disk drives, or a remote storage service 120. The server 100 may also have a suitable operating system 116 which resides on the disk drive or in the ROM of the server 100.

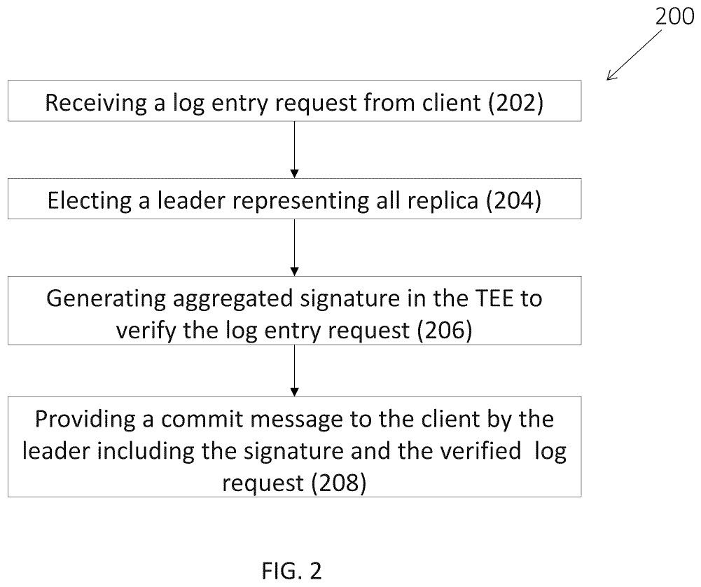

With reference to FIG. 2, there is shown an embodiment of the system for providing consensus to a transaction record in a distributed ledger, such as a transfer of fund from a digital wallet to a digital back account in financial institution. The transaction may be recorded by creating a log in a transaction ledger which may be implemented by a blockchain network including a plurality of computing nodes each storing a replica of log.

In this embodiment, the server 100 is used as part of the system which may execute instructions stored in the system such that it may carry out the method 200 illustrated in the Figure. The method 200 is provided for providing consensus to a transaction record in a distributed ledger, comprising the steps of: at step 204, electing a leader from a plurality of replicas associated with the transaction record in the distributed ledger; and at step 208, replying, by the leader, a commit message to a client, wherein the commit message includes a log entry requested by the client at step 202 and a plurality of digital signatures of the plurality of replicas; wherein the each of the plurality of digital signatures is generated using a private key of the respective one of the plurality of replicas at step 206; and wherein the private keys are stored in a trusted execution environment (TEE) and the generation of the plurality of digital signatures is executed in the TEE.

Preferably, the method 200 may be used for signing and verifying log entry that will be entered in a distributed ledger such as a blockchain network which is implemented with a plurality of replicas or nodes. As appreciated by a skilled person in the field, nodes or replicas may be any electronic device with sufficient computational power and storage capacity, such as servers, desktops, or cloud-based virtual machines. The replicas/nodes should to be configured to connect to the blockchain network, which involves setting up network parameters like IP addresses, ports, and peer connections. After configuration, nodes should be synchronized with the blockchain network. This process involves downloading the entire blockchain ledger and verifying its integrity.

Preferably, the replicas in a blockchain network may be implemented with the use of Distributed Ledger Technology (DLT), where each replica maintains a copy of the ledger and participates in the consensus process to ensure data consistency and integrity. Replicas can be implemented using various DLT platforms, such as Hyperledger Fabric, which supports permissioned networks with fine-grained access control.

Preferably, the consensus process may be facilitated by the computer processor running a consensus algorithm to enhance e-currency facilitated by blockchain technology using a distributed ledger, where the consensus process results is passed to one of the replicas in the blockchain network implementing the distributed ledger, such that a client terminal, may be notified that the transaction has been successfully logged in the ledger.

Without wishing to be bound by theory, a consensus process may be important in a blockchain-based transaction platform because it may ensure that all participants in the network agree on the state of the blockchain. One of its primary functions is to validate transactions, ensuring they are legitimate and adhere to the network's rules. This validation process prevents issues like double-spending and other fraudulent activities, maintaining the integrity of the transactions.

Another critical function of a consensus process is to ensure that all nodes in the network agree on a single version of the blockchain. This agreement is vital for maintaining a consistent and accurate ledger across all participants. Additionally, consensus process provides fault tolerance, allowing the network to continue functioning correctly even if some nodes fail or act maliciously. This capability ensures the robustness and reliability of the blockchain.

Consensus processes may also enable decentralization by allowing multiple nodes to participate in the decision-making process. This decentralization removes the need for a central authority and distributes power across the network, enhancing the system's security. For instance, in Proof of Work (PoW), altering the blockchain would require an immense amount of computational power, making it difficult for attackers to succeed.

Preferably, the process may first involve electing a leader from a plurality of replicas in the blockchain network, operating like an agent which represents all replicas in the subsequent communication between the client and the blockchain network. For example, the TEE-assisted consensus process may be based on Raft, where Raft's state transition conditions ensure that only a correct and up-to-date replica can become the leader.

For example, the system may operate by electing a leader from among the nodes (or replicas) in the system. The leader is responsible for managing the log replication process and ensuring that all nodes agree on the same sequence of operations. To ensure that only a correct and up-to-date replica can become the leader, the system enforces specific state transition conditions during the leader election process.

When a node becomes a candidate for leadership, it may start an election by sending out RequestVote messages to other nodes. Each node that receives a RequestVote message will grant its vote to the candidate only if the candidate's log is at least as up-to-date as its own log. This condition ensures that the candidate has the most recent information and is in sync with the majority of the nodes.

The up-to-date check involves comparing the term numbers and the indices of the last entries in the logs. A candidate's log is considered up-to-date if its last log entry has a higher term number than the last log entry of the voter, or if the term numbers are the same but the candidate's log is longer. This mechanism prevents outdated nodes from becoming leaders and ensures that the new leader has the most recent and accurate state of the system.

By enforcing these state transition conditions, it may be ensured that only a node with the latest and correct information can become the leader. This helps maintain the consistency and reliability of the distributed system, as the leader is responsible for coordinating the log replication and ensuring that all nodes agree on the same sequence of operations.

When the leader receives a log entry from a client, it proposes this entry to the replicas by sending them a message to append the entry to their logs. The replicas then receive the proposed log entry and append it to their logs. They then send an acknowledgment back to the leader, indicating that they have successfully appended the entry.

By employing a “centralized signing or verification” approach in accordance with embodiments of the present invention, a digital signature as acknowledgment provided by each of the replicas may be unnecessary, instead, the signature is generated using the replica's private key and serves as proof that the replica has indeed appended the log entry is generated by the consensus module or the processor in the TEE where the replica's private key are stored in the repository in the TEE. The leader collects these signed acknowledgments from a majority of the replicas. Once it has received enough votes from the replicas, it can be confident that the log entry has been safely replicated.

In the cryptographic techniques being employed, the leader may preferably reply to the client with a commit message that includes digital signatures from the replicas, indicating that the respective log entry request has been verified by the blockchain network and will be entered into the distributed ledger, i.e. stored in each of a plurality of replicas in the blockchain network. By using digital signatures, the system ensures that the commit message sent to the client is trustworthy and that the log entry has been correctly replicated across the majority of the nodes. This mechanism enhances the security and reliability of the distributed system, preventing unauthorized modifications and ensuring that the client can trust the commit.

The private key for these signatures is securely stored in a Trusted Execution Environment (TEE), and the signing process is executed within the TEE, ensuring the security and integrity of the process. Advantageously, providing the TEE for signing the transaction or the log entry request may boost the efficiency of the blockchain based transaction, in particular the signing and verification process as the consensus process may be completed within the TEE without requiring to circulate the request by different computational nodes. In addition, security of the system is ensured as the keys are stored in the repository within the TEE which may have a different level of security in the entire system.

These signatures provide cryptographic proof that the majority of replicas have agreed to the log entry, ensuring its integrity and authenticity. More preferably, the system may be further improved by incorporating threshold signatures, e.g. the plurality of digital signature in the commit message is in form of an aggregated signature, and the aggregated signature is a threshold signature having a threshold (n, t) denoting at least t out of n replicas agree on the log entry in a voting process. For example, the threshold may be set to 5 out of 7 which indicate the transaction has been verified by a majority of all nodes/replicas to create the log in the distributed ledger and thus the transaction can be process.

This feature aggregates digital signatures from replicas with a threshold (n, t), which enables using a single public key for verifying the aggregated signature. The aggregated digital signature may be may be equivalent to generating a single digital signature by a series of encryption/verification process using multiple private keys, therefore a single public key may be used for verifying the digital signature generated based on multiple private keys. This approach simplifies the verification process, as a single aggregated signature represents the voting result, reducing the need to send and verify multiple signatures. The signing process is also conducted inside the TEE, maintaining the security benefits. It is preferable that the response time between receiving the log entry and providing the commit message is less than or equal to 5 seconds.

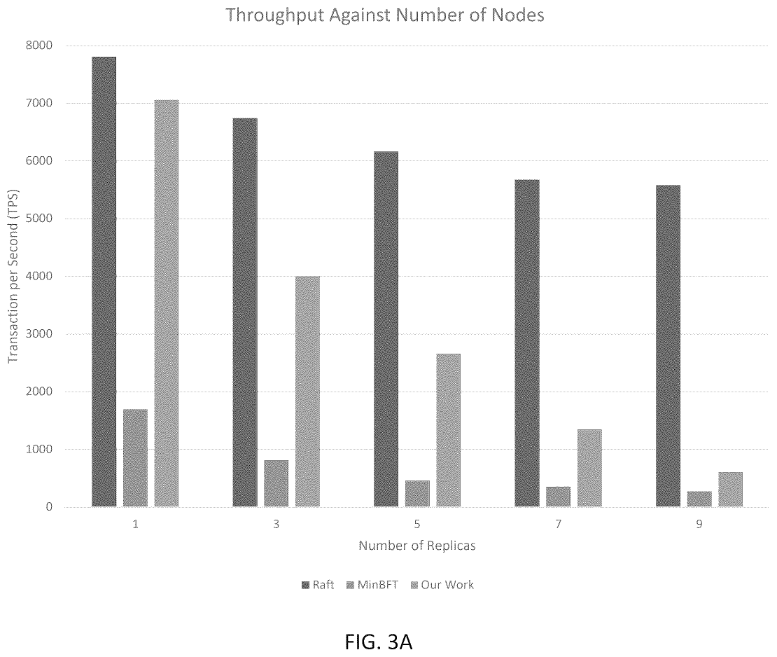

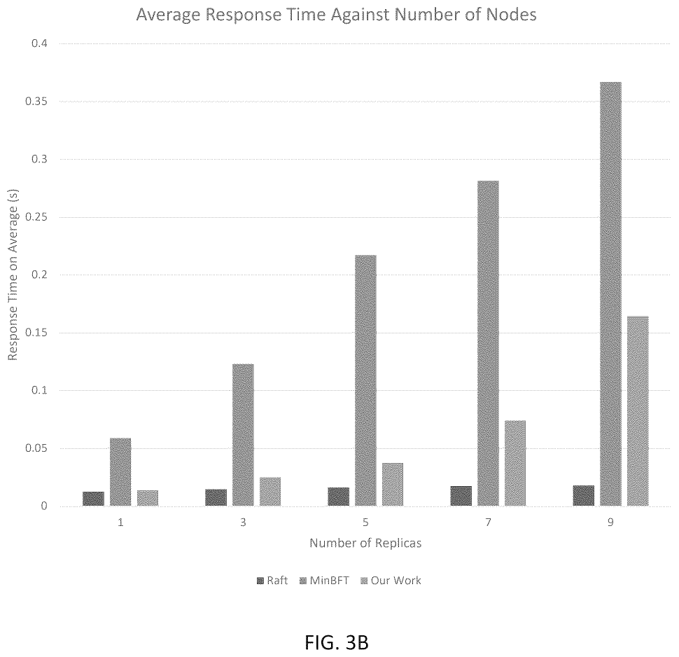

Referring to FIGS. 3A and 3B, there is shown plots illustrating testing of the system with promising results. In this testing, the expected performance was a throughput of 500 transactions per second (TPS) with a response time of no more than 5 seconds when n=7. The actual performance exceeded expectations, achieving more than 500 TPS when f=4 and an average response time of less than 1 second, specifically a throughput of more than 1000 transaction per section (TPS) referring to FIG. 3A and an average response time of less than 0.3 second for each transaction referring to FIG. 3B, when the number of nodes n equal to 7. These results were benchmarked with reference to Raft and MinBFT.

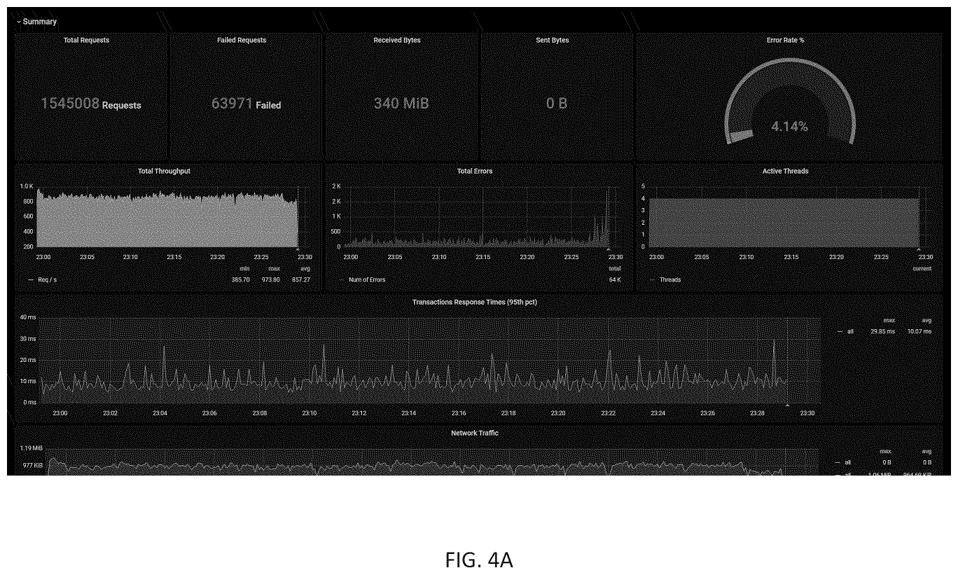

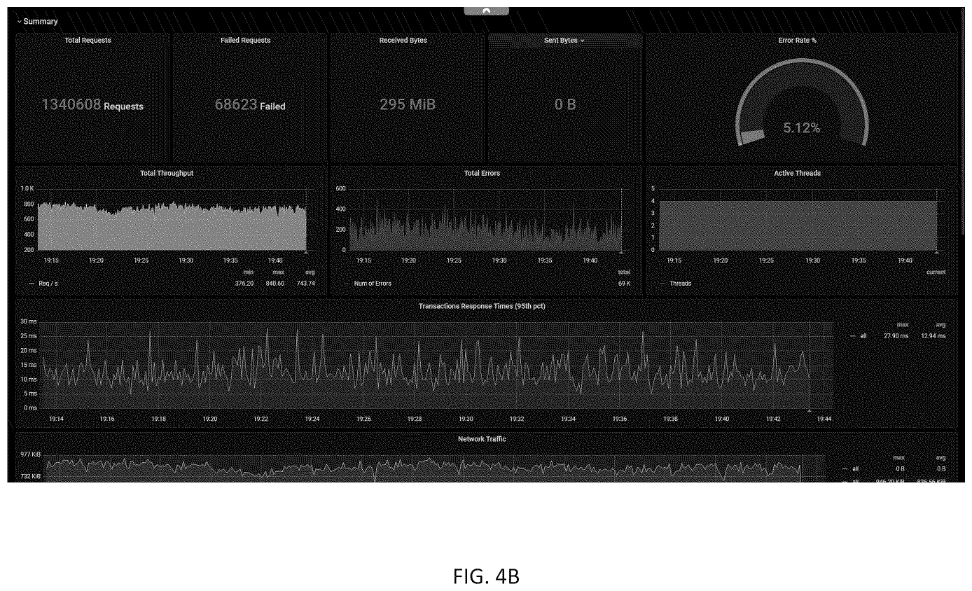

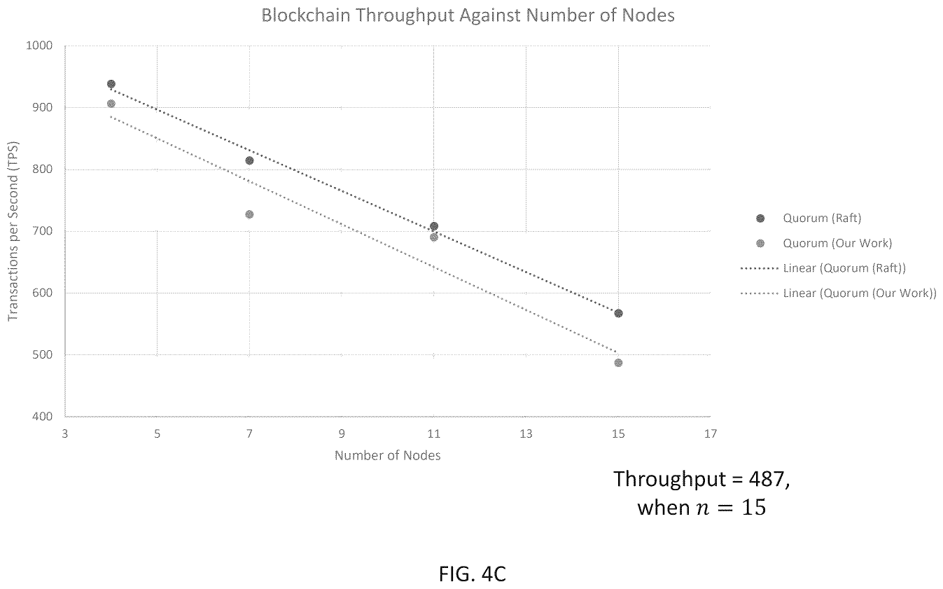

A proof-of-concept implementation of the blockchain powered by the TEE-assisted consensus method in accordance with the present invention was integrated with ConsenSys Quorum, a fork of Ethereum (go-ethereum). This implementation inherited most of Ethereum's features, supported various consensus mechanisms including Raft, and enabled private transactions and contracts for enterprise use-cases. A 7-node blockchain network was set up for this purpose. With reference to FIG. 4A, it can be observed that transaction response time was less than 30 ms. The results were benchmarked with quorum profiling as shown in FIGS. 4B and 4C. Specifically, as shown in FIG. 4C, the throughput of the system in accordance with an embodiment of the present invention is 487 when n=15.

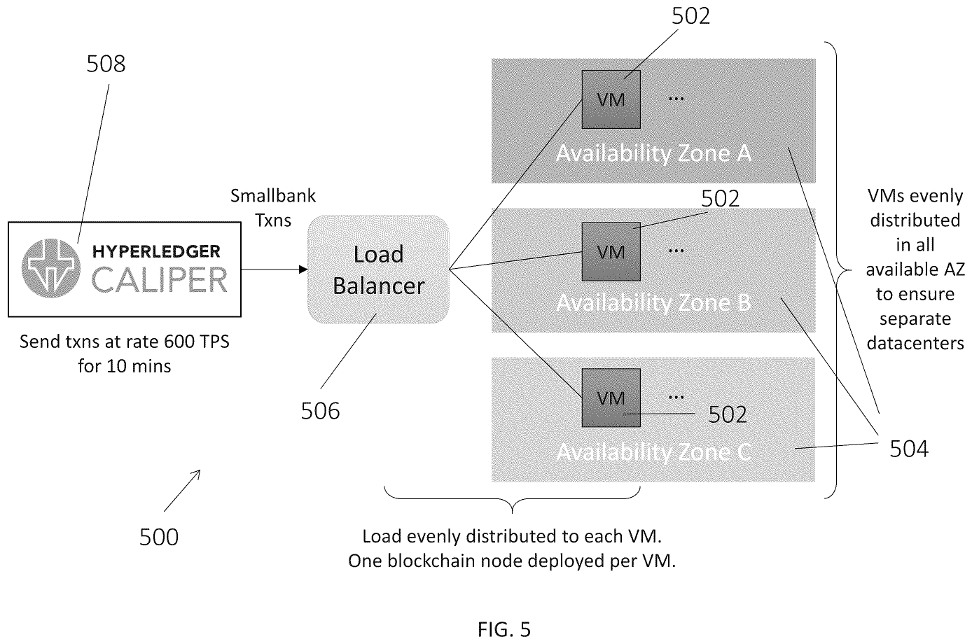

With reference to FIG. 5, further performance testing was conducted using Hyperledger Caliper, a blockchain performance benchmark framework, on the “smallbank” test case. This test case simulates a series of bank operations such as creating accounts, querying balances, and performing deposits and payments. In addition, random transactions were generated to simulate operating on accounts.

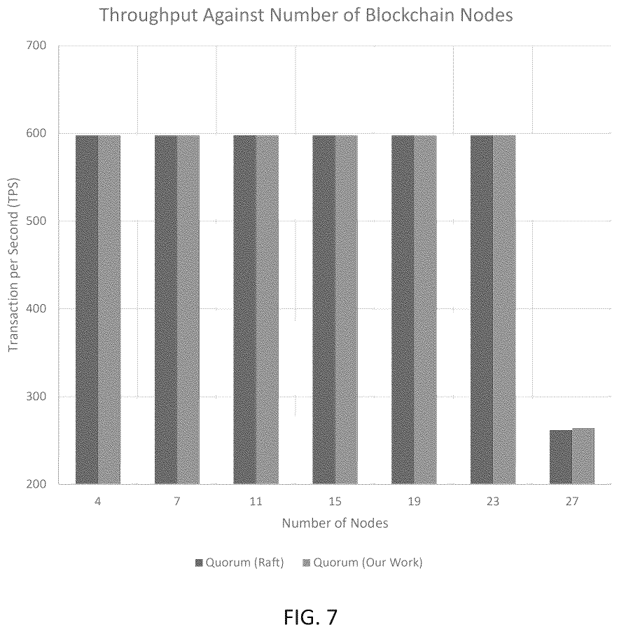

Hyperledger Caliper is a blockchain performance benchmark framework. It allows users to test different blockchain solutions using predefined use cases and obtain performance metrics. Some key features includes: Supported Blockchain Solutions: Hyperledger Caliper supports multiple blockchain platforms, including Hyperledger Besu, Hyperledger Fabric, and Ethereum; and Performance Metrics: It measures various performance indicators such as transaction/read throughput, transaction/read latency (minimum, maximum, average), and resource consumption (CPU, memory, network I/O). An HTML Report, generated by Hyperledger Caliper after each benchmark may be obtained referring to FIG. 7.

The testing distributed ledger 500 was built with a load balancer 506 connecting multiple nodes or replicas implemented using virtual machines 502 (VM). During operation, all VMs 502 were evenly distributed in all available zones 504 to ensure separate datacenters. The benchmarking process was carried out with txns being sent to the load balancer 506 at a rate of TPS for 10 minutes, from the Hyperledger caliper benchmarker 508. The expected performance was a throughput of 500 TPS with a response time of no more than 5 seconds.

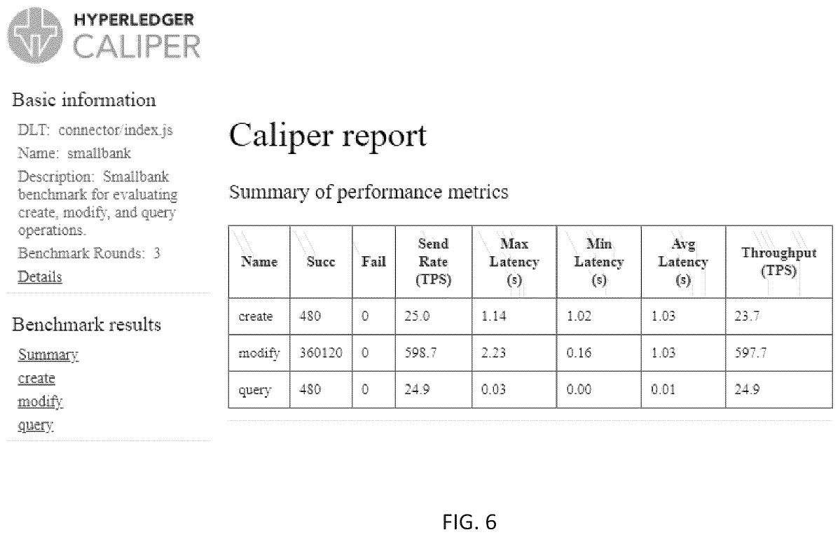

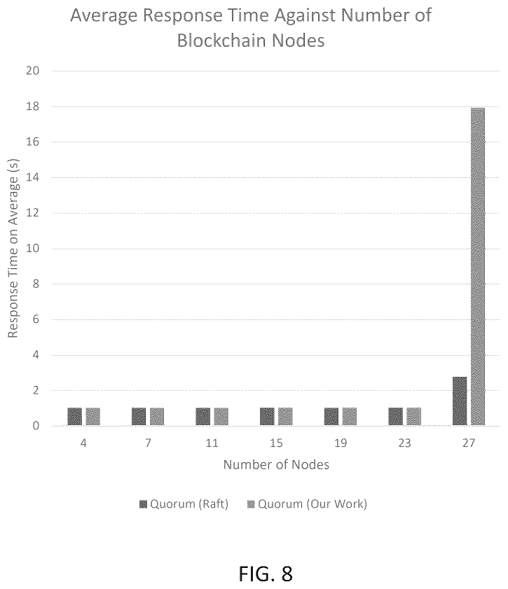

With reference to FIGS. 6 to 8, the actual performance, as benchmarked with Hyperledger Caliper, showed a throughput of 594.0 TPS when the send rate was 596.0 TPS, and an average response time of 1.02 seconds. These results demonstrate the effectiveness and efficiency of the TEE-assisted consensus process in a practical setting.

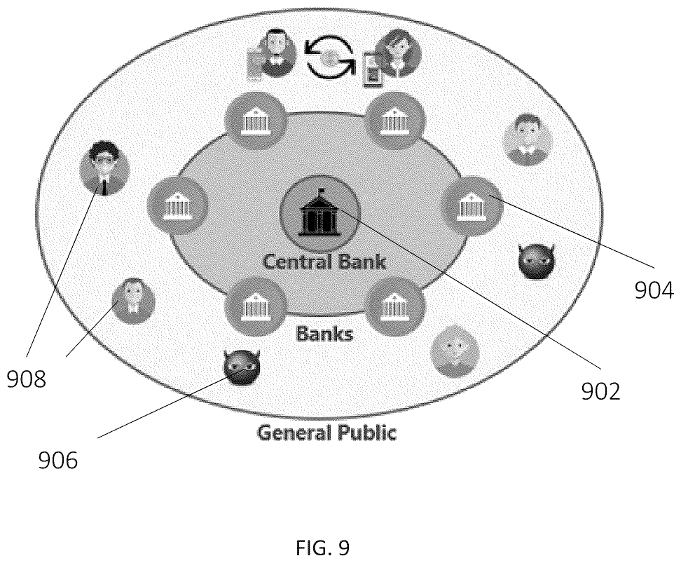

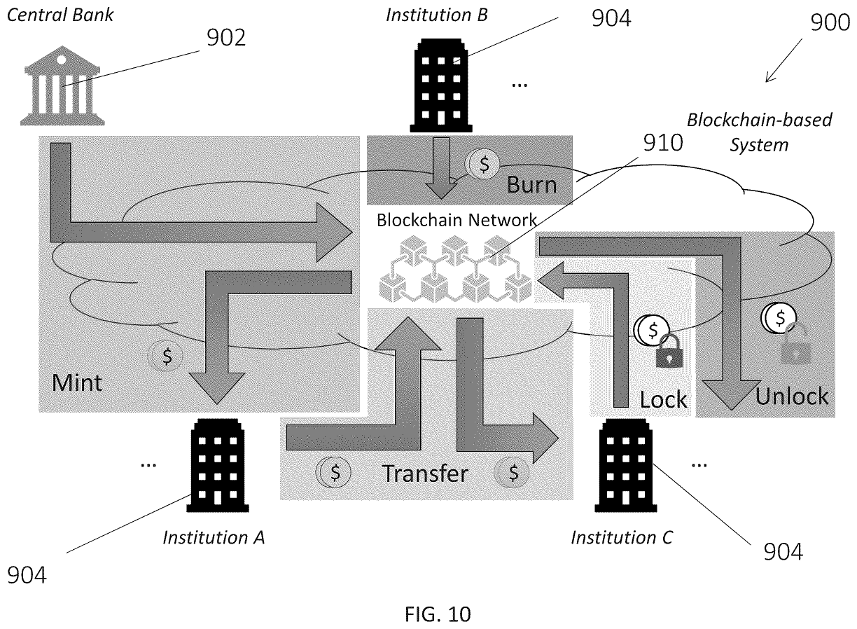

With reference to FIGS. 9 to 10, there is shown an example embodiment of a payment system 900 facilitating transaction among multiple clients, such as electronic terminals operated by a central bank 902, a financial institution 904, a payment service provider 906 or a user 908 of financial services, where the transaction record is associated with an operation of minting, burning, transferring, locking or unlocking fund. The system preferably includes a distributed ledger 910 arranged to record a transaction record upon receiving a log entry requested by a client, wherein the distributed ledger is implemented with a plurality of replicas; and a consensus module arranged to provide consensus to the transaction record in the distributed ledger where the consensus module includes a processor operating in a trusted execution environment (TEE) as previously described in this disclosure.

For example, a burn fund operation may be initiated by a financial institution 904, the operation may involve permanently removing a certain amount of cryptocurrency from circulation. This may be done by sending the tokens to a burn address, which is a special address that cannot be accessed or spent from. The purpose of burning tokens can include Reducing Supply: By decreasing the total supply of tokens, the value of the remaining tokens can potentially increase due to scarcity; Increasing Value: It can help stabilize or increase the value of the cryptocurrency by reducing inflation.

In an alternative example, a mint fund operation may be initiated by a central bank 902, where a mint fund operation refers to the creation of new tokens. This process may be useful for rewarding participants: New tokens can be minted to reward network participants, such as miners or validators, for their contributions; Fund Development: Newly minted tokens can be allocated to fund development projects, ecosystem growth, or community incentives; and Expand Supply: It can be used to increase the total supply of tokens to meet demand or support new initiatives.

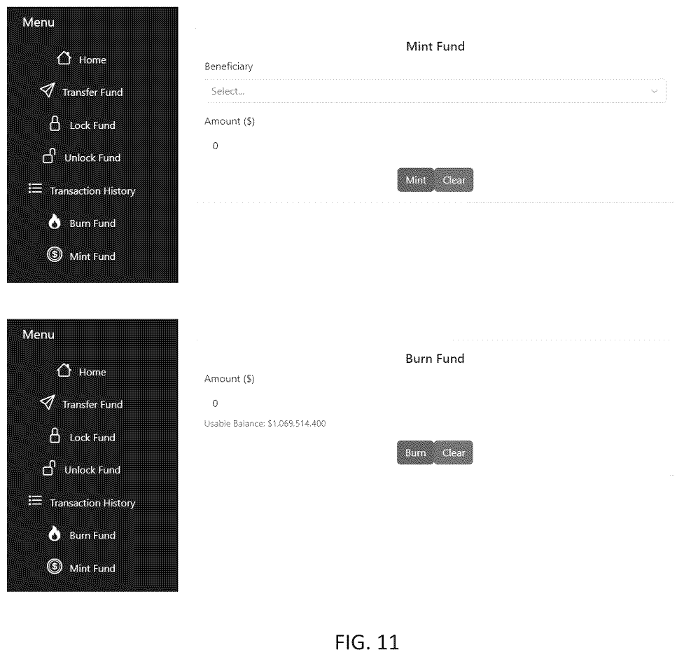

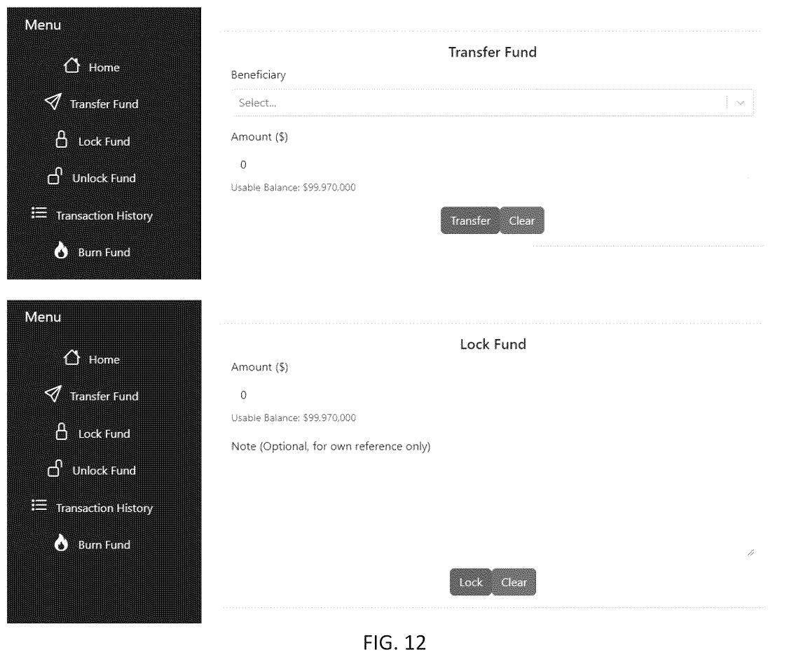

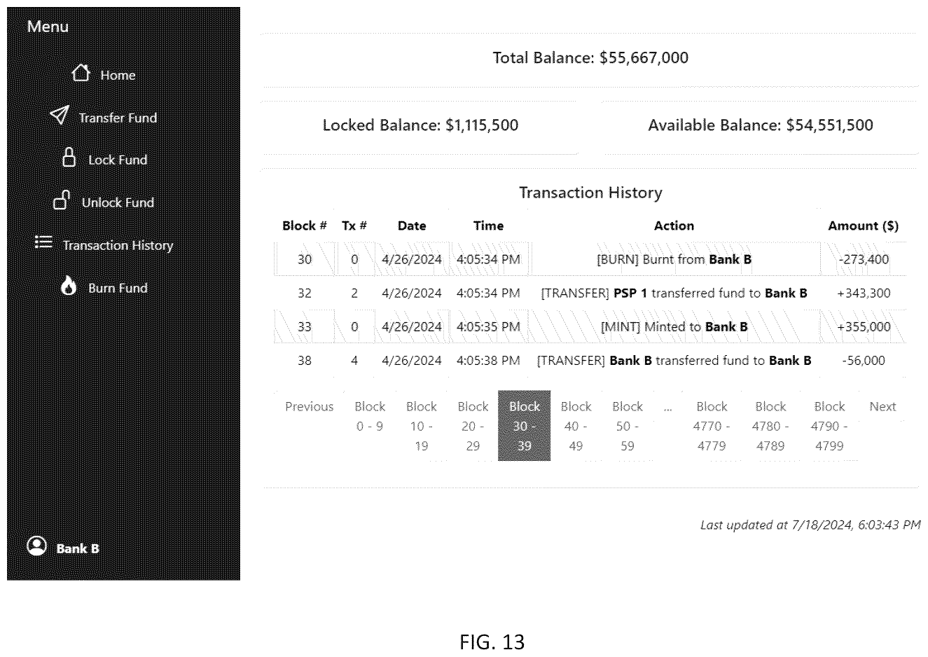

Referring to FIG. 10, other transitions may include transferring fund from one financial institution to another institution, e.g. in a payment transaction, and locking/unlocking fund managed by a financial institution 904, e.g. upon receiving a law enforcement order provided. These operations may be facilitated by a platform provided with suitable user interfaces, referring to FIGS. 11 to 13, where the platform may be administrated by the central bank 902 issuing the fund or tokens being logged in the distributed ledger in accordance with an embodiment of the present invention.

Although not required, the embodiments described with reference to the figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A system for providing consensus to a transaction record in a distributed ledger, comprising:
a processor operating in a trusted execution environment (TEE) arranged to generate a plurality of digital signature in the TEE using a private key of a respective one of a plurality of replica, wherein the private keys are stored in the TEE;
wherein the plurality of replicas includes a leader being elected from the plurality of replicas associated with the transaction record in the distributed ledger; and
wherein the plurality of digital signature is included in a commit message provided by the leader to a client in a reply, and the commit message further includes a log entry requested by the client.

2. The system in accordance with claim 1, wherein the distributed ledger is implemented by a blockchain network comprising the plurality of replicas.

3. The system in accordance with claim 2, wherein the plurality of digital signature in the commit message is in form of an aggregated signature.

4. The system in accordance with claim 3, wherein the aggregated signature is a threshold signature having a threshold (n, t) denoting at least t out of n replicas agree on the log entry in a voting process.

5. The system in accordance with claim 4, wherein the aggregated signature is verified in the TEE using a single public key.

6. The system in accordance with claim 1, wherein the transaction record is associated with an operation of minting, burning, transferring, locking or unlocking fund in a payment system.

7. A method of providing consensus to a transaction record in a distributed ledger, comprising the steps of:
electing a leader from a plurality of replicas associated with the transaction record in the distributed ledger; and
replying, by the leader, a commit message to a client, wherein the commit message includes a log entry requested by the client and a plurality of digital signatures of the plurality of replicas;
wherein the each of the plurality of digital signatures is generated using a private key of the respective one of the plurality of replicas; and
wherein the private keys are stored in a trusted execution environment (TEE) and the generation of the plurality of digital signatures is executed in the TEE.

8. The method in accordance with claim 7, wherein the distributed ledger is implemented by a blockchain network comprising the plurality of replicas.

9. The method in accordance with claim 8, wherein the plurality of digital signature in the commit message is in form of an aggregated signature.

10. The method in accordance with claim 9, wherein the aggregated signature is a threshold signature having a threshold (n, t) denoting at least t out of n replicas agree on the log entry in a voting process.

11. The method in accordance with claim 10, wherein the aggregated signature is verified in the TEE using a single public key.

12. The method in accordance with claim 7, wherein the transaction record is associated with an operation of minting, burning, transferring, locking or unlocking fund in a payment system.

13. A payment system comprising:
a distributed ledger arranged to record a transaction record upon receiving a log entry requested by a client, wherein the distributed ledger is implemented with a plurality of replicas;
a consensus module arranged to provide consensus to the transaction record in the distributed ledger;
wherein the consensus module includes a processor operating in a trusted execution environment (TEE) arranged to generate a plurality of digital signature in the TEE using a private key of a respective one of a plurality of replica, wherein the private keys are stored in the TEE;
wherein the plurality of replicas includes a leader being elected from the plurality of replicas associated with the transaction record in the distributed ledger; and
wherein the plurality of digital signature is included in a commit message provided by the leader to the client in a reply, and the commit message further includes the log entry requested by the client.

14. The payment system in accordance with claim 13, wherein the distributed ledger is implemented by a blockchain network comprising the plurality of replicas.

15. The payment system in accordance with claim 14, wherein the plurality of digital signature in the commit message is in form of an aggregated signature.

16. The payment system in accordance with claim 15, wherein the aggregated signature is a threshold signature having a threshold (n, t) denoting at least t out of n replicas agree on the log entry in a voting process.

17. The payment system in accordance with claim 16, wherein the aggregated signature is verified in the TEE using a single public key.

18. The payment system in accordance with claim 13, wherein the transaction record is associated with an operation of minting, burning, transferring, locking or unlocking fund.

19. The payment system in accordance with claim 18, wherein the client includes an electronic terminal operated by a central bank, a financial institution, a payment service provider or a user of financial services.

20. The payment system in accordance with claim 13, wherein a response time between receiving the log entry and providing the commit message is less than or equal to 5 seconds.
